(19) United States
(12) Patent Application Publication
(10) Pub. No.: US 2018/0168174 A1
(43) Pub. Date: Jun. 21, 2018

(54) METHOD TO TRANSPORT LIQUID MILK

(71) Applicant: MILKWAYS HOLDING B.V., Hattem (NL)

(72) Inventor: Diederick Joost Servaes BRASSER, Hattem (NL)

(73) Assignee: MILKWAYS HOLDING B.V., Hattem (NL)

(21) Appl. No.: 15/737,475

(22) PCT Filed: Jun. 17, 2016
(86) PCT No.: PCT/NL2016/050430

§ 371 Date: Dec. 18, 2017

(30) Foreign Application Priority Data
Jun. 19, 2015 (NL) 2015003

(51) Int. Cl. A23C 3/04; A23C 3/03; A23C 3/00; A23C 7/02; B63B 25/16

(52) U.S. Cl. CPC A23C 3/04; A23C 3/03; B63B 25/16; A23C 7/02; A23C 3/005

(57) ABSTRACT

The invention is directed to a method to transport liquid milk to obtain transported liquid milk during a supply chain time of more than 10 days wherein during at least a 90% of the duration of the supply chain time the liquid milk is kept at a temperature of less than 2° C. A ship is provided in the supply chain with one or more containers for carrying between 40 and 5000 M³ liquid milk. Raw milk is subjected to a pasteurization thermal treatment to obtain processed milk for transport by the ship in the supply chain.

The invention is directed to a method to transport liquid milk during a supply chain time of more than 10 days.

Assuring the safety of fluid milk, related dairy products and juices while maintaining quality and increasing the shelf life of products is a significant challenge for the food industry. Thermal inactivation of spoilage and pathogenic microorganisms, i.e. Thermal pasteurization, is the most widely used method to achieve these goals. For nearly 100 years milk and other foods have been thermally pasteurized to inactivate microorganisms which might cause human disease and to inactivate inherent enzymes and spoilage microorganisms to make milk last longer.

Unfortunately, thermal pasteurization can have detrimental effects on flavour and nutritional quality. Although thermal pasteurization improves safety and prolongs shelf life, it often causes a decrease in flavour quality, nutritional content, for example vitamin loss, and other quality factors like colour.

Many attempts to mitigate the undesirable effects while maintaining the desirable effects of thermal pasteurization have been undertaken. Nearly all of this work has focused on improved methods of transferring heat into and out of the product to minimize thermal damage. For example processes known as HTST (high temperature short time) pasteurization and UHT (ultra high temperature) processing result in milk products which may have a prolonged shelf life.

In Murray S K et al., “Effect of nitrogen flushing on the production of proteinase by psychrotropic bacteria in raw milk”, Journal of food science, Wiley-Blackwell Publishing, Inc, US, Vol 48 (1983), pages 1166-1169 it is described that raw milk flushed with nitrogen and stored at 4 C less microflora growth was observed as compared to aerobically stored raw milk at 4 C.

In Sri Haryani et al., “Production of proteinases by psychrotrophic bacteria in raw milk stored at low temperatures”, Australian Journal of Diary Technology, Vol. 58, No. 1-April 2003 it is described that the quality of raw milk stored at low 2° C. is better than raw milk stored at 4 or 7° C. after 10 days.

FR646190 describes a method to prolong the storage life of raw milk by creating a frozen layer of raw milk which would protect the enclosed liquid raw milk against loss of quality.

FR2224716 describes a vessel for chilling and holding milk at 0° C. as it is collected at farms for carriage to creameries.

A disadvantage of these milk products having the improved shelf life as obtained by the high thermal treatment processes is that the milk cannot be used for other purposes than as a liquid for direct consummation. For example, UHT treatment results in ambient stable products but strongly denatures the milk protein in such a way that application of this kind of milk for other dairy products is greatly reduced. Such milk is therefore not suited as a feedstock for making cheese by fermentation. There is a desire to transport milk over long distances which milk still has its proteins, i.e. milk which has not been thermally treated or at least not severely thermally treated. This is especially relevant if one realises that milk is produced economically in locations which are located far away from the locations where milk is used for consumption and/or cheese or yoghurt production. The currently accepted method to transport milk over greater distances is by first making milk powder and transporting the milk powder. A disadvantage of this method is that the milk obtained after adding water before consumption does not contain all of the nutrients of the starting milk.

Although various methods and techniques have been known for some time to preserve the quality of milk over a longer time period no integral method has been developed which enables one to transport liquid milk over a greater distance, i.e. during a supply chain time of more than 10 days, while maintaining an acceptable quality of the milk. The quality of the milk is here defined as the total mesophilic bacteria count.

The object of the present invention is to provide a method to transport liquid milk during a supply chain time of more than 10 days wherein the quality of the liquid milk remains acceptable.

This is achieved by the following method. Method to transport liquid milk to obtain transported liquid milk during a supply chain time of more than 10 days wherein during at least a 90% of the duration of the supply chain time the liquid milk is kept at a temperature of less than 2° C., wherein the liquid milk is subjected to at least the following means of transport and/or storage and wherein the time of transport and/or storage is the supply chain time: the transport of a raw milk from a dairy farm to a processing facility by means of a local carrier, transport of a processed milk from the processing facility optionally via a storage facility to a long distance—large volume carrier, transport from one location to another distant location by means of the long distance—large volume carrier, transport of the processed milk from the long distance—large volume carrier to a destination storage facility or directly to a local carrier, storage at the destination storage facility and transport from the destination storage facility or from the long distance—large volume carrier to a production facility by means of a local carrier, and

wherein the large volume carrier is a ship provided with one or more containers for carrying between 40 and 5000 M³ liquid milk, and

wherein at the processing facility the raw milk is subjected to a thermal treatment to obtain the processed milk.

Applicants found that if the temperature of liquid pasteurized milk can be kept at these lower levels for such a prolonged time the quality of the milk can be kept within the acceptable limits for use of the milk and transported over large distances in large quantities.

Suitably the supply chain time is more than 20 days. Even at these higher supply chain times the quality of the milk remains within the acceptable quality limits. The lower limit for the temperature is the solidification temperature of the liquid milk. This limit will be determined by the composition of the milk and for example its fat content.

Applicants found that the method is suited for milk which has or has not been subjected to a homogenization treatment. A homogenization treatment results in that milk fat globules are purposely reduced in size and purposely dispersed uniformly through the rest of the milk as compared to freshly milked milk. Non-homogenised milk is less susceptible for quality loss due to enzymatic activity during transport. Any creaming which may occur due to the fact that the liquid milk is not homogenised can be easily reversed at the end of the transport of part of the transport, for example by gently mixing the cream and milk.

The thermal treatment may be a thermal treatment wherein the raw milk is subjected to a thermal treatment between 57 and 80° C. at the processing facility to obtain the processed milk. The holding or residence time may be between 5 seconds and 45 minutes, preferably between 5 and 300 seconds. This treatment may involve a mild thermisation at about 57 and 68° C. for about 12-20 seconds. A preferred thermal treatment is a Pasteurization as performed within this temperature range. Pasteurization is a microbiocidal heat treatment aimed at reducing the number of any pathogenic microorganisms in milk and liquid milk products, if present, to a level at which they do not constitute a significant health hazard. Pasteurization conditions are designed to effectively destroy the organisms Mycobacterium tuberculosis and Coxiella burnetii. The pasteurization conditions may be those having bactericidal effects equivalent to heating the raw milk to 72° C. for 15 seconds in a continuous flow pasteurization or at 63° C. for 30 minutes in a batch pasteurization and similar conditions obtained by joining the line connecting these points on a log time versus temperature graph. These conditions may vary and a skilled person may easily, based on the above, understand what is meant by Pasteurization. For example, Pasteurized milk as obtained by a thermal treatment at 76° C. for 20 seconds as used in the examples of this application is also an example of processed milk obtained by Pasteurization.

More severe thermal treatments result in that spores in the milk start to germinate causing spoilage of the milk after 17 days according to Barbano, D. M., Y. Ma et al., (2006) “influence of raw milk quality on fluid milk shelf life”. Journal of Dairy Science 89 (E. Supplement): E15-E19.

The raw milk which is subjected to the above thermal treatment may be obtained from the farms in any manner. Preferably the raw milk is relatively fresh and obtained by applying hygienic methods and equipment at the farm and during transport to the facility at which the thermal treatment is performed. By fresh milk is here meant any raw milk having a mesophilic bacteria count of less than 50000 cfs/mL used as feed for the thermal treatment.

The fresh milk either before or after the thermal treatment may be subjected to a so-called microfiltration process. Preferably such a microfiltration process is performed before the pasteurization treatment. In such a process microorganisms, which may be detrimental to the quality of the liquid milk, are separated from the milk. Examples of suitable processes are described in WO14098596, WO2010/085957 and US2010/0310711, which publications are incorporated by reference. The microorganisms may also be separated from the milk by processes which make use of a centrifuge, like for example the Bactofuge process.

Applicant found that milk can be transported during a long supply chain time at the conditions as described above. Additional measures to even more prolong the supply chain time are described below which may be used alone or in combination.

A first measure is to achieve a low concentration of dissolved oxygen in the milk, suitably less than 0.3 mg/l during more than 50% of the duration of the supply chain time to suppress the growth of any aerobic microorganisms in the liquid milk. The levels of oxygen in the liquid milk may be lowered by handling and storing the liquid milk product under an inert atmosphere like for example nitrogen. Preferably the milk is transported in a container and wherein above the liquid milk a gaseous space is present which gaseous space is comprised of an inert gas. The inert gas may be preferably nitrogen.

Preferably during or before the transportation of the liquid milk the level of oxygen in the milk is decreased to a level below 0.3 mg/l and more preferably below 0.1 mg/l. The level of oxygen may be lowered by means of for example oxygen scavengers as described in for example WO9612646, by reaction with hydrogen as for example described in WO13087239 or by reaction with carbon as described in US2012076901.

Because contacting with oxygen scavengers may require complex installations it is preferred that such contacting is performed when larger quantities of liquid milk is transported at a time. For example, if part of the transport is performed by a ship is may be advantageous to perform contacting with oxygen scavengers during that part of the transport. On board of a ship, carrying larger quantities of liquid milk than a truck, it is more practical to install these more complex installations.

Another example of an additional measure is to contact the liquid milk with an antimicrobial agent during transportation. Because of the relatively long contact time between liquid milk and such antimicrobial agent an effective decrease or growth inhibition may be achieved. Such antimicrobial agents may be present on the surface of the containers in which the liquid milk is transported or may be present in filters through which part of the liquid milk is passed through during transport. Such a filter may for example comprise a polymer foam provided with a zeolite/silver as described in WO09033618A1.

Because contacting with an antimicrobial agent may require complex installations it is preferred that such contacting is performed when larger quantities of liquid milk is transported at a time. Furthermore relatively long contact times may be required. For example, if part of the transport is performed by a ship is may be advantageous to perform contacting with oxygen scavengers during that part of the transport. On board of a ship, carrying larger quantities of liquid milk than a truck, it is more practical to install these more complex installations and the supply chain time by ship will typically be longer than the on-land transport.

A further additional measure is to add carbon dioxide to the liquid milk before, during or after the milk has been subjected to an optional thermal treatment, like the above referred to mild thermal treatment or mild pasteurization. Suitably all or part of the carbon dioxide is subsequently removed before use of the liquid milk, for example at or near the destination of the milk transport. Some of the carbon dioxide will form carbonic acid in the liquid milk which in turn will lower the pH of the milk. This more acidic environment will result in the death of microorganisms and will thus enhance the quality of the milk over time. The content of added carbon dioxide is suitably between 400 and 2000 ppm. The presence of the added carbon dioxide is furthermore advantageous because it lowers the solidification temperature of the liquid milk and thus enables one to perform the method according to the invention at even lower temperatures. The use of carbon dioxide to extend the shelf life of milk is for example described in US2002/0127317, which publication is hereby incorporated by reference.

The period of time in which the liquid milk is comprised of the added carbon dioxide is suitably as long as possible. In a situation wherein part of the transport is performed by a ship it is preferred that the ship is loaded with the liquid milk already comprising the added carbon dioxide. Suitably the carbon dioxide is removed or partly removed from the liquid milk at the end of the transport by ship. Such removal may be performed by creating a vacuum in the containers in which the liquid milk is transported. Creating a vacuum is not preferred when the containers cannot withstand large pressure differences. When such containers are used carbon dioxide may also be removed by replacing the carbon dioxide with an inert gas like nitrogen or even replacing the carbon dioxide with air. This may be performed on-board the ship just at the end of the transport by ship or during the further handling. Removal on-board the ship is advantageous because it avoids that the end users of the liquid milk need to perform such carbon dioxide removal.

The supply chain time is the time the liquid milk is either transported or stored somewhere between the cow which produces the milk and the end user. More especially the supply chain time comprises the time the liquid milk is subjected to any one or more of the following means of transport and/or storage: the transport from the dairy farm to a processing facility by means of a local carrier, transport from the processing facility to a storage facility, storing at the storage facility, transport from a storage facility to a long distance—large volume carrier, transport from one location to another distant location by means of the long distance—large volume carrier, transport from the long distance—large volume carrier to a destination storage facility or directly to a local carrier, storage at the destination storage facility and transport from the destination storage facility or from the long distance—large volume carrier to a production facility by means of a local carrier.

An example of a possible supply chain time comprises the time the liquid milk is subjected to the following means of transport and/or storage: the transport from the dairy farm to a processing facility by means of a local carrier, transport from the processing facility to a storage facility, storing at the storage facility, transport from a storage facility to a long distance—large volume carrier, transport from one location to another distant location by means of the long distance—large volume carrier, transport from the long distance—large volume carrier to a destination storage facility or directly to a local carrier, storage at the destination storage facility and transport from the destination storage facility or from the long distance—large volume carrier to a production facility by means of a local carrier.

The transport of a processed milk from the processing facility to the long distance—large volume carrier is preferably over a short distance wherein this transport does not involve transport by a local carrier, like milk trucks and the like. Preferably the processing facility and storage facility for processed milk is located nearby where the long distance and large volume carrier is loaded, i.e. at the harbour where the ship is loaded. Preferably the processed milk is aseptically stored and aseptically transferred between a holding container of the storage facility and the container of the long distance—large volume carrier as will be described in more detail below.

In order to reduce the supply chain time it is preferred that at the storage facility and/or the destination storage facility the liquid milk is stored according to the first in—first out method. Preferably more than one holding containers at a departing storage facility, more than one containers on board the ship and more than one holding containers at the destination storage facility have the same volume or capacity. This allows that a volume of milk as part of one departure holding container and of a certain age time since thermal processing can be transported segregated from the other volumes of milk having a different age and ultimately stored at the destination storage facility segregated from the other volumes of milk in a separate holding container. This method allows that the relative older milk as stored at the destination storage facility can be transported to end users or processed first and separate from the relatively younger milk. This may result in a more complex storage facility but the reduction in supply chain time of the separate milk volumes may be several days when this method is applied.

Another example of a possible supply chain time comprises the time the liquid milk is subjected to the following means of transport and/or storage: the transport from the dairy farm to a long distance—large volume carrier, transport from one location to another distant location by means of the long distance—large volume carrier, transport from the long distance—large volume carrier to a local carrier, and transport to a production facility by means of a local carrier.

The above described thermal treatment may also take place when the milk is being transported by the long distance—large volume carrier. This may be advantageous when the milk is directly provided to the long distance—large volume carrier from the dairy farm without any intermediate storage.

The dairy farm will for example be local farmers which hold cow stock. The local carrier may for example be road trucks or even small ships if the farms are located at a waterway. The processing facility may comprise any facility where the liquid milk sourced from numerous dairy farms is subjected to a treatment, like for example the above referred to thermal treatment, microfiltration and/or carbon dioxide addition. The storage facility may be at the same location or different location as the processing facility. For example processing facility and storage facility may be located at a harbour connected to the sea or near train rails.

The long distance—large volume carrier is a ship and more preferably a sea-going ship. These ships are preferably provided with one or more containers suited for carrying the liquid milk. Each of such a container carry between 40 and 5000 M³ liquid milk. These ships will be provided with means to cool the containers and liquid milk to the required lower temperatures. These ships may further be provided with means to maintain an inert, preferably nitrogen, blanketing above the liquid milk, means to maintain a low level of oxygen in the liquid milk, means to create a vacuum to remove carbon dioxide and/or filters with antimicrobial agents such as described above. The containers on-board such a ship may be constructed as being an integral part of the ships structure. Alternatively the containers are built separately and added as such to a ship, suitably also comprising the cooling means and optional process equipment as described earlier. This enables a modular approach wherein the modules can be added to an existing ship. Such containers and ships are known for transport of liquid products, such as fruit juice, and are for example described in EP0658494 and WO12008826. These containers are not meant to be removed together with its content from the ship. Instead the liquid milk will be pumped from these containers after arrival.

When arriving at the destination of the long distance—large volume carrier the liquid milk may be discharged from the container(s) of the carrier into one or more containers of the destination storage facility. The container is preferably provided with stirring means or agitators to mix the milk before unloading. In that way any large particles formed as a result of creaming in the milk can be reduced in size making unloading by means of pumps more easy. Preferably such a facility is provided with cooling means to keep temperature at the desired lower temperatures. The milk may also be directly discharged into the container or containers of a local carrier, for example a road truck. The local carriers may transport the liquid milk to a production facility where the liquid milk may be converted into for example consumption milk, yoghurt or cheese.

In the above supply chain from farm to production facility it is not necessary that the liquid milk is kept at the low temperatures according to the method of this invention. It may be conceivable that the duration of the supply chain time at which the liquid milk is kept at a temperature of less than 2° C. starts when the liquid milk is stored just after being processed in the processing facility. It may also be conceivable that the local carriers at the destination location are not always equipped with suitable cooling means. Because the supply chain time at which the milk is transported from for example a harbour and the production facility is relatively short no unacceptable decrease in milk quality will be expected.

Preferably the liquid milk is aseptically stored and aseptically transferred between the above described holding containers. More especially, the liquid milk is aseptically stored and aseptically transferred between a holding container of the storage facility and the container of the long distance—large volume carrier. The milk will thus be aseptically stored and transported in the long distance—large volume carrier. Preferably the milk will also be aseptically transferred between the container of the long distance—large volume carrier and a holding container of the destination storage facility. Aseptic processing is the process by which a sterile product is packaged in a sterile container in a way that maintains sterility. Aseptic processing, containers and valves are well known and for example described in U.S. Pat. No. 3,678,955, U.S. Pat. No. 3,871,824, U.S. Pat. No. 3,918,678, U.S. Pat. No. 3,918,942 and U.S. Pat. No. 3,998,589. For this invention aseptic has the meaning that the containers and the piping and pumps required for loading and unloading the liquid milk to and from the containers are aseptic.

Usually liquid milk is transported in containers which can be cleaned and sterilised at elevated temperatures, for example using steam. The use of such high temperatures required containers which can withstand pressure differences and thus thicker vessel walls, i.e. pressure vessels. The general opinion is that increasing the size of the containers to transport liquid milk is not feasible because the vessels would become too heavy and complex to manufacture. Applicants now found that large containers in which the liquid milk is stored and transported may be made aseptic by sterilisation in a manner which does not require pressure vessels. This finding enables the use of larger containers as described above which in turn enables one to transport liquid milk over large distances in large quantities. The containers and especially the large volume containers as used on the long distance—large volume carrier is suitably cleaned and sterilised before loading the liquid milk by a cleaning and sterilisation process comprising the steps of rinsing the container with water, rinsing with a aqueous solution comprising a soap and contacting the inner surface of the container with a fog of aqueous droplets wherein the droplets comprise an acid liquid sanitizer. The fog may be in air or an inert gas, like for example nitrogen. The fog is preferably applied at a temperature between 0 and 60° C. Preferably the acid liquid sanitizer comprises hydrogen peroxide and peroxyacetic acid. Examples of suitable acid liquid sanitizers are Oxania Active of Ecolab Inc. or aqueous compositions comprising hydrogen peroxide, peroxyacetic acid and octanoic acid as for example described in U.S. Pat. No. 5,314,687.

The invention is also directed to a non-homogenised liquid milk as transported by the method according the invention, suitably comprising between 10 and 50 ppm nitrogen and/or between 100 and 1000 ppm carbon dioxide.

### EXAMPLE

The following types of milk were stored for 40 days at 0.3° C.±0.2° C.: A=raw milk; B=non-homogenized pasteurized milk; C=direct UHT milk; D=non-homogenized thermized milk; E=homogenized pasteurized milk; F=indirect UHT milk. Thermized milk was obtained by a thermal treatment at 62.5° C. for 120 seconds. Pasteurized milk was obtained by a thermal treatment at 76° C. for 20 seconds. UHT milk was obtained by a thermal treatment at 142° C. for 4 seconds.

A selected number of samples were taken to obtain an indication of the microbiological quality of the milk as part of the shelf life test. The microbiological quality at the start (t=0 days) and the end (t=40 days) of the shelf life test was assessed by a total plate count for mesophilic bacteria. In the below table the total plate count of the different milk variants at the start and the end of the shelf life test and pH value at the end of the shelf life test is provided.

| | | t = 0 days | t = 40 days | t = 40 days |
|---|---|---|---|---|
| Milk Code | Milk variant | (cfu/mL) | (cfu/mL) | (pH) |
| A | raw milk | 1.8 * 10⁴ | 2.4 * 10⁸ | 5.98 |
| B | non-homogenized | 5.2 * 10³ | 2.6 * 10³ | 6.74 |
| | pasteurized milk | | | |
| C | direct UHT milk | <1.0 * 10² | <1.0 * 10² | 6.75 |
| D | non-homogenized | 1.1 * 10⁴ | 3.1 * 10⁸ | 6.14 |
| | thermized milk | | | |
| E | homogenized | <1.0 * 10² | <1.0 * 10² | 6.74 |
| | pasteurized milk | | | |
| F | indirect UHT milk | <1.0 * 10² | <1.0 * 10² | 6.70 |

The number of total mesophilic bacteria at t=0 days was in all milk variants at an acceptable level (<105/mL). After 40 days of storage at 1° C., only variants A and D (raw and thermized milk, respectively) contained an increased number of mesophilic bacteria. The pH value of these two variants had dropped to 6.0-6.1. It is interesting that for variant B (pasteurized milk) no growth of mesophilic bacteria was observed. This indicates that the population grown in variant A and D was most probably of psychrotrophic origin which were killed during the pasteurization process. This experiment shows that pasteurization is the most suitable heat treatment as regards shelf-life and applicability of the milk.

1. Method to transport liquid milk to obtain transported liquid milk during a supply chain time of more than 10 days wherein during at least a 90% of the duration of the supply chain time the liquid milk is kept at a temperature of less than 2° C., wherein the liquid milk is subjected to at least the following means of transport, storage, or both, and wherein the time of transport, storage, or both, is the supply chain time: the transport of a raw milk from a dairy farm to a processing facility by means of a local carrier, transport of a processed milk from the processing facility optionally via a storage facility to a long distance—large volume carrier, transport from one location to another distant location by means of the long distance—large volume carrier, transport of the processed milk from the long distance—large volume carrier to a destination storage facility or directly to a local carrier, storage at the destination storage facility and transport from the destination storage facility or from the long distance—large volume carrier to a production facility by means of a local carrier, and
wherein the large volume carrier is a ship provided with one or more containers for carrying between 40 and 5000 M³ liquid milk, and
wherein at the processing facility the raw milk is subjected to a thermal treatment to obtain the processed milk.

2. The method according to claim 1, wherein the raw milk is subjected to a thermal treatment between 57 and 80° C. at the processing facility to obtain the processed milk.

3. The method according to claim 2, wherein the thermal treatment is a Pasteurisation treatment.

4. The method according to claim 1, wherein the raw milk has a mesophilic bacteria count of less than 50000 cfu/mL.

5. The method according to claim 1, wherein the supply chain time is more than 20 days.

6. The method according to claim 1, wherein the milk has not been subjected to a homogenization treatment.

7. The method according to claim 1, wherein the containers of the large volume carrier are cleaned and sterilised before loading the liquid milk by a process comprising the steps of rinsing the container with water, rinsing with an aqueous solution comprising a soap and contacting the inner surface of the container with a fog of aqueous droplets wherein the droplets comprise an acid liquid sanitizer.

8. The method according to claim 7, wherein the acid liquid sanitizer comprises hydrogen peroxide and peroxyacetic acid.

9. The method according to claim 1, wherein in the container of the large volume carrier a gaseous space is present above the liquid milk comprising of an inert gas.

10. The method according to claim 1, wherein the processed milk is aseptically stored and aseptically transferred between a holding container of the storage facility and the container of the long distance—large volume carrier.

11. The method according to claim 10, wherein the storage facility stores the processed milk according to the first in-first out method.

12. The method according to claim 10, wherein the milk will be aseptically stored and transported in the container of the long distance—large volume carrier and aseptically transferred between the container of the long distance—large volume carrier and a holding container of the destination storage facility.

13. A ship comprising one or more containers each container suited for aseptically carrying between 40 and 5000 M³ liquid milk, means to cool the containers and liquid milk, means to maintain an inert blanketing above the liquid milk and stirring means or agitators to mix the milk.

14. The ship according to claim 13, wherein the container or containers are built separately and added as such to a ship and wherein the container is not meant to be removed together with its content from the ship.

15. The method of claim 1, performed using the ship according to any one of claims 13-14 as the large volume carrier.

16. The method of claim 2, wherein the raw milk has a mesophilic bacteria count of less than 50000 cfu/mL.

17. The method of claim 3, wherein the raw milk has a mesophilic bacteria count of less than 50000 cfu/mL.

18. The method of claim 11, wherein the milk will be aseptically stored and transported in the container of the long distance—large volume carrier and aseptically transferred between the container of the long distance—large volume carrier and a holding container of the destination storage facility.
